(19) United States
(12) Patent Application Publication
(10) Pub. No.: US 2008/0040384 A1
(43) Pub. Date: Feb. 14, 2008

(54) NEAREST SEARCH ON ADAPTIVE INDEX WITH VARIABLE COMPRESSION

(75) Inventor: Tsia Kuznetsov, Cupertino, CA (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 11/770,426

(22) Filed: Jun. 28, 2007

Related U.S. Application Data
(60) Provisional application No. 60/806,367, filed on Jun. 30, 2006.
(60) Provisional application No. 60/806,366, filed on Jun. 30, 2006.

(51) Int. Cl. G06F 17/30

(52) U.S. Cl. 707/103 Y; 707/E17.055

(57) ABSTRACT

A search system can search nodes of a tree to find the object stored in the tree that is nearest to a position input by the user. The tree can be constructed using object keys with interlaced coordinates such that nodes in the tree correspond to a bounding box that bounds a subset of objects. The search algorithm can find the nearest object to a position.

### CLAIM OF PRIORITY

This application claims priority from the following co-pending applications, which are hereby incorporated in their entirety: U.S. Provisional Application No. 60/806,366 entitled: “ADAPTIVE INDEX WITH VARIABLE COMPRESSION”, by Tsia Kuznetsov, et al., filed Jun. 30, 2006, (Attorney Docket No. TELA-07780US0) and U.S. Provisional Application No. 60/806,367 entitled: “NEAREST SEARCH ON ADAPTIVE INDEX WITH VARIABLE COMPRESSION”, by Tsia Kuznetsov, filed Jun. 30, 2006, (Attorney Docket No. TELA-07781US0).

### BACKGROUND OF INVENTION

A number of applications can use stored spatial data to provide spatial search services for a user. The applications can include mobile or stationary mapping systems, which can include map rendering, spatial object search, path search, directions and positioning.

It is often the case that the user wishes to locate an object in a given coordinate system and gain further information about that object. In a complex database with many objects it can be a problem to quickly find the object that is closest to the input position. Especially, if the system is memory constrained as in a mobile navigation device.

### BRIEF DESCRIPTION OF THE DRAWINGS

FIG. 1 illustrates a map-based system using the search of the present invention.

FIGS. 2A-2E illustrates the construction of a tree of one embodiment of the present invention.

FIG. 3 is a flowchart of a search method of one embodiment of the present invention.

FIGS. 4A-4B illustrates bounding boxes for nodes of one example.

FIGS. 5A-5F illustrates an exemplary search of one embodiment.

FIG. 6 illustrates an example where nodes contain indications of other search criteria, such as exclusion information.

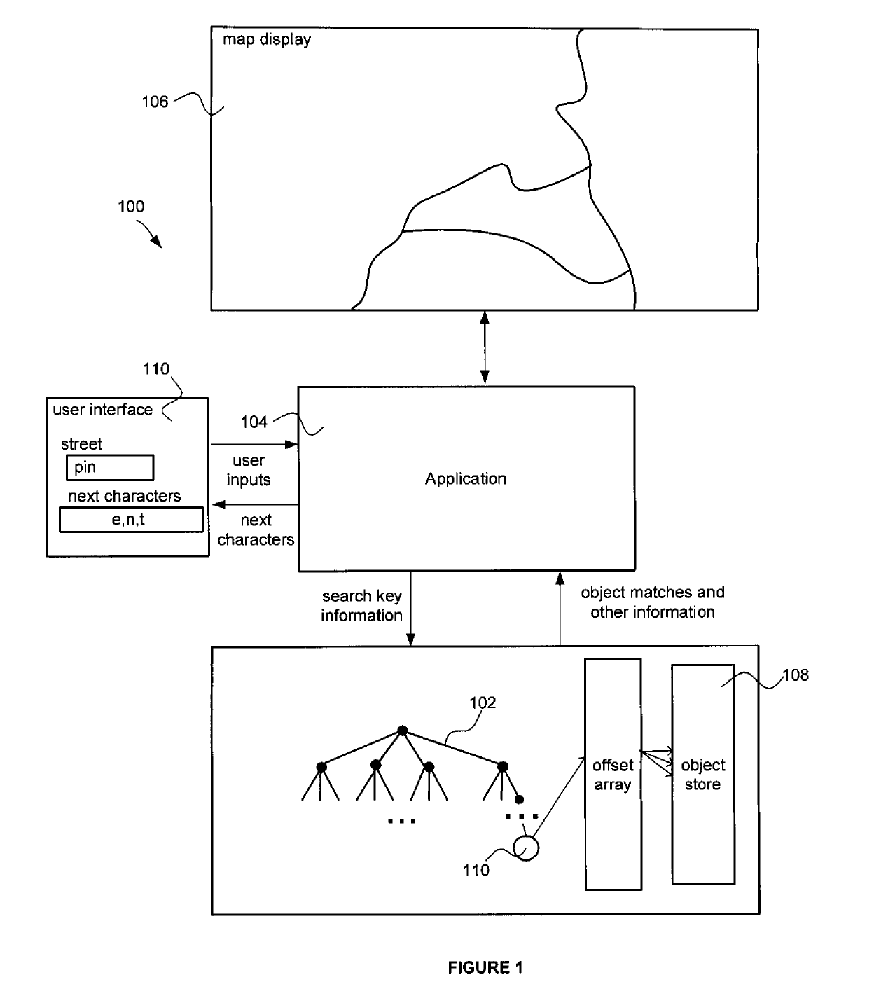

### DETAILED DESCRIPTION

One embodiment of the present invention is a computer-implemented method comprising a search system that searches nodes of a tree 102 for the nearest object. The tree can be constructed for a set of objects, each with a spatial coordinate key(s) such that nodes in the tree correspond to a bounding box that is bounding a subset of these objects. The search can find the nearest object to a position.

In one embodiment, the bounding boxes of the tree nodes below the root only cover regions where objects are present. This can optimize the storage of the objects and the retrieval of the potential nearest objects. Similarly, in one embodiment, the bounding boxes of children nodes only cover regions where objects are present. The bounding box of the root node can be such that it does not include some regions without relevant objects.

In one embodiment, latitude and longitude coordinates can be used. For example, digits of the latitude and longitude coordinates can be interlaced in the string key as described below.

The precision of encoded object key increases at every node on a path from the root to a leaf. The extent of the associated bounding boxes decreases from the root to a leaf. The extent can be intrinsic to the coordinate key system. For example, the extent can be one unit of distance at the highest precision of the key for a given direction. One example of an interlaced coordinate system discussed below has the extent of the bounding box in either coordinate direction decreasing by a factor of ten for each child node.

In an alternate embodiment, stored extent values can be used.

In one embodiment, the leaf nodes can point to multiple objects. The tree can be constructed to yield leaf nodes that tend to maximize the number of objects in a leaf based on a given criteria. In one embodiment, the specified pruning criteria is that each tree node at least objects in its offspring, otherwise that branch can be pruned and objects assigned to leaf nodes.

A maximum search radius value can be maintained to bound the search. The search radius value can be decreased based on bounding box information. The minimum and the maximum distance from a position to each node can be calculated using node bounding boxes. Nodes can be eliminated from consideration based on the maximum search radius value. In one example, nodes whose bounding box has a minimum distance from a position greater than the maximum search radius can be ignored.

Object key information for a node can be sufficient to encode a bounding box corner position and extent. In one example, when coordinate information is interlaced, a corner, such as the lower left corner, of the node's bounding box can be determined by de-interlaced coordinates, and the extent of the bounding box for each coordinate can be determined from the make-up of the coordinates.

The computer-implemented method can be part of a map system 100 or a navigation system. The objects can include spatial objects such as road segments, points of interest (POIs) or other spatial objects. The spatial objects can be indicated by one or more coordinates.

One embodiment of the present invention is a system 100 comprising an application 104. The application 104 can include an interface to obtain a position. The application can use a spatial search that searches nodes of a tree for the nearest object. The tree 102 can be based on a spatial key encoded with coordinates such that a node in the tree corresponds to a bounding box that is bounding a subset of these objects. The search can find the nearest object to a position.

The application 104 can have a map display 102. The application can use non-visual means to convey information to a user such as an aural presentation.

One example of how object coordinates can be used to create a tree is given as follows:

To create a key from a latitude and a longitude:
1. translate decimal degrees into integer coordinates where a given number of bits represent circumference of the Earth
2. move coordinates into positive space
3. turn each integer into a string
4. prepend each string with ‘0’s to make them equal in length
5. make a search key by interlacing decimal digits of the latitude and the longitude into the key string
   suppose latitude string contains “00123”
   suppose longitude string contains “00078”
   resulting interlaced string key will be “0000102738”

This spatial key can be used to build the coordinate index a. Precision of the key can increase at every node on the path from the root to a leaf.

For storage and retrieval optimization, leaf node keys in the index can be truncated to equal their parent's key, thus forcing leaves to merge, This can require the search to follow object references to the object store for the final step in selecting the nearest object

A nearest search can be implemented on the tree 102. The bounding box of each node on the search path can be restored from the node's spatial key. To retrieve node bounding box for the spatial search:
Each tree node can store a prefix of a key, with the key prefix of lowest precision at the root and the key prefix with highest precision at the leaf. In the adaptive index with variable compression these key prefixes can be reduced such that a full key of every node is a concatenation of all key prefixes from the root to the node. This concatenation then yields the full key for that node; each node's key can encode the lower left corner and the extent of the node's bounding box.

In one embodiment, to compute node's lower left corner and spatial extent of its bounding box:
De-interlace node's spatial key; append missing ‘0’ the resulting latitude and longitude strings to full length (5 in our example) represent the lower left corner.
a) in one example, suppose a node key is “0000102”
   latitude is “00120”, where the appended “0” means that the latitudes of the node's children are between 120-129, thus the extent of node's latitude is 10 to the power of 1
   longitude is “00000” where the appended “00” mean that the longitudes of the node's children are between 0-99, thus the extent of node's longitude is 10 to the power of 2.
b) in another example, suppose node key is “00001027”
   latitude is “00120” and the latitudes of the node's children are between 120-129, thus the extent of node's latitude is 10 to the power of 1.
   longitude is “00070” and the longitudes of the node's children are between 70-79, thus the extent of node's longitude is 10 to the power of 1.

To complete the computation of node's lower left corner, translate string latitude and longitude into integer coordinates and return the integers into the original coordinate space.

Node bounding box can be computed from the lower left corner integer latitude and longitude coordinates of the lower left corner and the spatial extend

FIGS. 2A-2E illustrates the construction of a tree of one example.

FIG. 2A shows an exemplary map with road segment points shown as X's. As shown in FIG. 2B, latitude and longitude of referenced point coordinates can be interlaced into a key. The keys can be used to construct a node tree as shown in FIG. 2C. The portion of the key at each node can be used to decode bounding boxes for nodes in the manner described above. In the example of FIG. 2C, node 210 (0000102738) corresponds to the bounding box 202 of FIG. 2A; node 212 (000010273) corresponds to the bounding box 204 of FIG. 2A; node 214 (00001027) corresponds to the bounding box 206 of FIG. 2A.

The leaf node 210 can point to an object in the object store 216, or store an object directly. The object can contain name and other information, as well as one or more coordinates. In one example, the object coordinates can be a road segment midpoints or endpoints. The pointer can thus be used to locate the object with the specific latitude and longitude coordinates in the bounding box 202.

As described in the U.S. Patent Application, ADAPTIVE INDEX WITH VARIABLE COMPRESSION, Ser. No. 60/806,366, (corresponding to attorney docket number TELA-07780US0), filed on Jun. 30, 2006 and hereby incorporated by reference, the leaf node can contain multiple references to objects. In the example of FIG. 2D, the leaf node points to two objects in bounding box 204. In the example of FIG. 2E, the leaf node points to the 26 objects in bounding box 206.

An exemplary search on the node tree is described below:

Spatial search on adaptive compressed index

Given a point P with coordinate's lat, lon:

Read root node r and restore its bounding box

Compute maximum radius maxR from P to the farthest location in the root

ReturnValue can be a tuple (object, distance); it can be computed by the following procedure:

(object, distanceToObject) = FindNearestObject( ) (tree-node, maxR)

If node is a leaf,

retrieve nearest object and distanceToObject;
if distanceToObject < maxR, update:

maxR = distanceToObject
return (object, distanceToObject)

Read child nodes
For each child node, compute distance to P: a minD and a maxD,

eliminating from consideration children that have minD > maxR

Under root r, child nodes that are initially considered are:
(a, minD, maxD)
(f, minD, maxD)
(h, minD, maxD)

reduce maxR to the minimum of children's maxD
sort child array on minD
While child array is not empty, and min (children's minD) < maxR)

Chose the child-node with the smallest minD;
(object, distanceToObject) = FindNearestObject(child-node, maxR)

Return (object, distanceToObject)

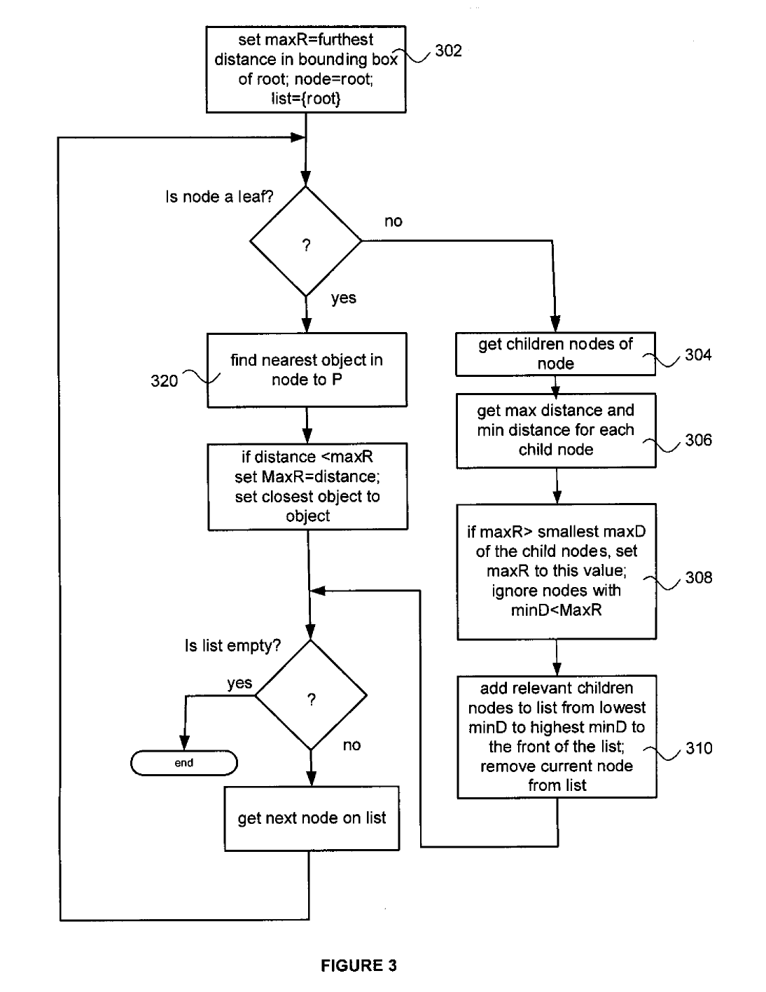

FIG. 3 shows an example of a flow chart that illustrates an exemplary search.

FIG. 4A shows the bounding boxes for the tree of FIG. 4B. FIG. 4A shows how bounding boxes for the children nodes are nested within the parent nodes. The size of the bounding boxes is not to scale.

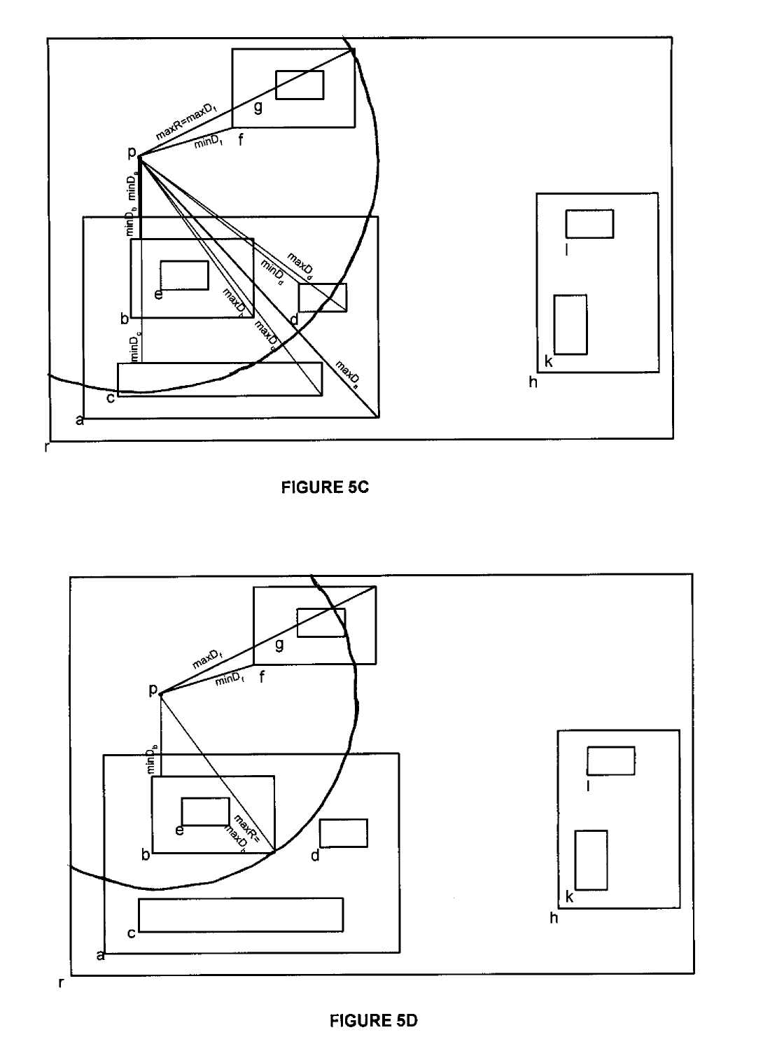

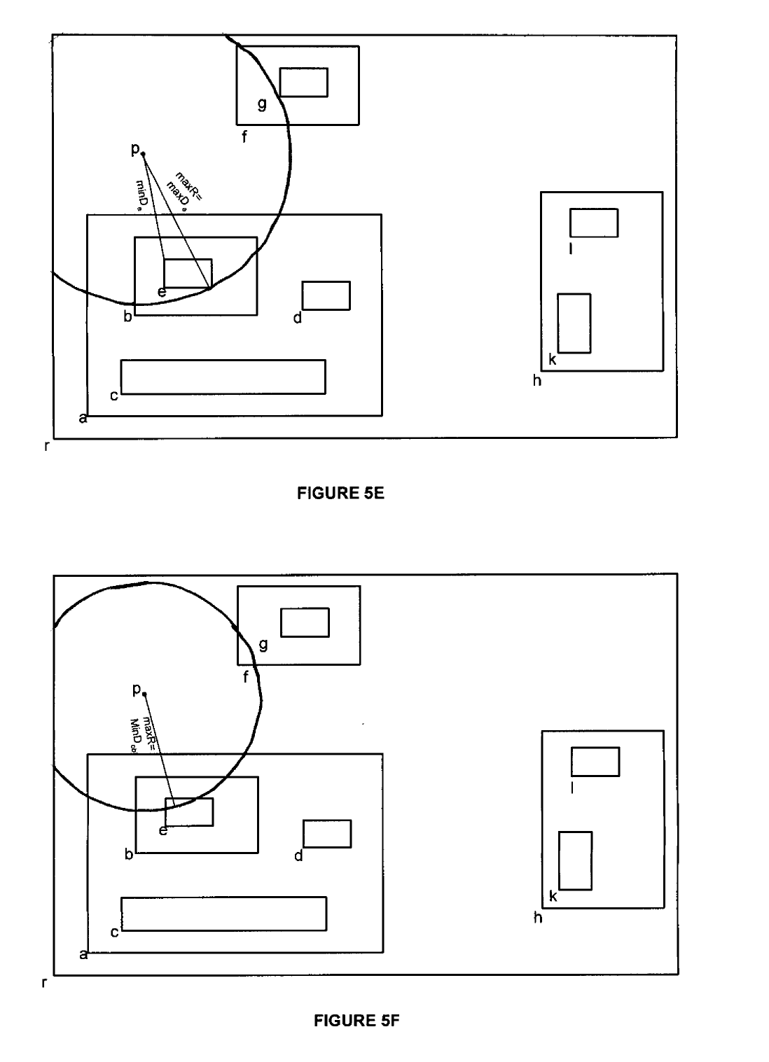

FIGS. 5A-5F shows an exemplary search. Point P can be determined from a user input such as from a cursor selection, from a touch screen selection or from another input means. Point P can also be obtained from the Global Positioning System (GPS) or other location determining system. The steps shown in FIG. 5A-5F show a way of searching the tree structure to find the closest object to the point P.

In FIG. 5A (corresponding to step 302 of FIG. 3), maxR is determined to be the distance from the point P to the furthest corner of the root node's bounding box. Since the root (node r) is not a leaf node, in step 304 of FIG. 3 the children nodes (nodes a, f, h) of the node are obtained.

The max and min distance for each bounding box of the children nodes can then be obtained (step 306 ). As shown in FIG. 5A, the max distance can correspond to the distance of a line from the point P to the furthest corner of the bounding box. The minimum distance can be, if possible, a straight line from the point P along a latitude or longitude value to a side of the bounding box or, if there are no such lines along a latitude or longitude, a line to the closest corner of the bounding box.

The maxR can be set to the shortest of the maxDs of the children nodes if it is less than the current maxR (this is step 308 of FIG. 3). The children nodes whose minD is bigger than maxR can be eliminated. In FIG. 5B, node h and its children can be ignored. The other nodes can be arranged in a list in order of ascending minD values (step 310 of FIG. 3) such that the node most probable to contain the nearest object is examined first. Thus, the list can be {a,f} at this point.

In FIG. 5C, the child nodes of node a are checked. In FIG. 5D, maxR is set to maxD of bounding box b. The list is {b, f} at this point.

In FIG. 5E, the children of node b are checked and the list becomes {e, f}.

In FIG. 5F, since node e is a leaf node, the objects in node e are checked to find the closest object to point P. Node e can have a number of pointers to objects in the object store. They can be checked to find the nearest object in node e. This corresponds to step 320 of FIG. 3. Since the distance to the object is less than the current maxR, maxR is set to the distance to the object. The list is now {f} at this point.

Node f is then checked and found to have child node g. Node g has a minD >maxR so the method ends and the nearest object among those found in node e is determined to be the nearest object to the position. The user can be given an indication of this object in a map display, a menu, or via some other type of user interface. For example, the name of the road can be displayed to the user and the road can be highlighted on the map, or the name of the road can be output via a text-to-speech digitizer.

In one embodiment, tree nodes can store indications of other search criteria. The nearest search can use the indications to implement an n-dimensional search. For example, in one embodiment, the searches can be filtered by category. The indications can include indications of categories that are included or not included in a bounding box of a node.

For example, a search for the closest restaurant to a position can eliminate from the search tree nodes that do not indicate presence of restaurants in their children.

In one embodiment, the nodes can store POI category exclusion information to simplify and speed up a search for a specific category. The exclusion information can indicate that no object in the bounding box for the node is in the category.

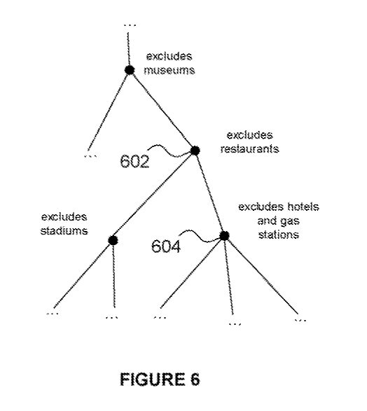

FIG. 6 shows one example. In this example, a search on the tree segment shown here can stop at node 602 if the search is for a restaurant and at node 604 if the search is for a gas station. The indications of other search criteria, such as exclusion information, can be implemented at the time of creation of the node tree.

One embodiment may be implemented using a conventional general purpose of a specialized digital computer or microprocessor(s) programmed according to the teachings of the present disclosure, as will be apparent to those skilled in the computer art. Appropriate software coding can readily be prepared by skilled programmers based on the teachings of the present discloser, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, Rams, EPROMs, EEPROMs, DRAMs, flash memory of media or device suitable for storing instructions and/or data stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

The forgoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments where chosen and described in order to best explain the principles of the invention and its practical application, thereby enabling others skilled in the art to understand the invention for various embodiments and with various modifications that are suited to the particular used contemplated. It is intended that the scope of the invention be defined by the claims and their equivalents.

1. A computer-implemented method comprising:
a search system that searches nodes of a tree for a nearest object, the tree constructed using object keys that encode coordinates such that nodes in the tree correspond to a bounding box that is bounding a subset of the objects, the search algorithm finding the nearest object to a position; wherein the bounding boxes of the tree nodes below the root only cover regions where objects are present and wherein the search eliminates nodes with certain bounding boxes from consideration.

2. The computer-implemented method of claim 1, wherein the precision of an encoded object key increases at every node on the path from the root to a leaf.

3. The computer-implemented method of claim 1, wherein the coordinates include latitude and longitude.

4. The computer readable medium of claim 1, wherein the object key information for a node is sufficient to encode its bounding box, such as by means of a corner position and extent.

5. The computer-implemented method of claim 1, wherein the coordinate information is interlaced.

6. The computer-implemented method of claim 5, wherein the lower left corner of the node's bounding box is determined by de-interlaced coordinates, and the extent of the bounding box for each coordinate is determined from the make-up of the coordinates.

7. The computer-implemented method of claim 1, wherein nodes store indications of other search criteria.

8. The computer-implemented method of claim 7, wherein the indications of other search criteria include indications of categories of objects that are not included in a bounding box of a node.

9. The computer-implemented method of claim 8, wherein the indications of other search criteria include indications of categories of objects that are included in a bounding box of a node.

10. The computer-implemented method of claim 1, wherein most leaf nodes point to multiple objects.

11. The computer-implemented method of claim 1, wherein the tree construction tends to maximize the number of objects associated with the leaf nodes based on a given criteria

12. The computer-implemented method of claim 1, wherein the method maintains a maximum search radius value and, based on the maximum search radius, eliminates from consideration some nodes.

13. The computer-implemented method of claim 1, wherein the method maintains a minimum distance to a position for nodes and uses the minimum distance to eliminate from consideration nodes whose minimum distance value is greater than the maximum search radius.

14. The computer-implemented method of claim 1, wherein the node's minimum and maximum distances to a position are calculated using the node's bounding box.

15. The computer-implemented method of claim 1, wherein the objects include spatial objects.

16. The computer-implemented method of claim 15, wherein the spatial objects include map geometry features.

17. The computer-implemented method of claim 15, wherein the spatial objects include points of interest.

18. The computer implemented method of claim 1, wherein the computer-implemented method is part of a mapping system.

19. A system comprising:
an application including an interface to obtain a position; wherein the application uses a search system that searches nodes of a tree for a nearest object to the position, the tree based on a search key with interlacing coordinates such that nodes in the tree correspond to a bounding box in given coordinates, the search finding the nearest object to a position, wherein the bounding boxes of the tree nodes below the root only cover regions where objects are present and wherein the search eliminates nodes with certain bounding boxes from consideration.

20. The system of claim 19, wherein the position is obtained based on a cursor selection.

21. The system of claim 19, wherein the position is obtained based on a user touch., a user location, a user voice input, or by other user interface means.

22. The system of claims 19, wherein the application includes a map display.

23. A computer-implemented system comprising:
a search system that searches nodes of a tree for a nearest object, the tree constructed using object keys that encode coordinates such that nodes in the tree correspond to a bounding box that is bounding a subset of objects, the search finding the nearest object to a position;
wherein the system maintains an overall maximum search radius value and a minimum distance for certain nodes and wherein the system uses the minimum distance to eliminate from consideration nodes whose minimum distance is greater than the maximum search radius.

24. A computer-implemented method comprising:
a search system that searches nodes of a tree for a nearest spatial object, the tree constructed using object keys that encode coordinates such that nodes in the tree correspond to a bounding box that is bounding a subset of the objects, the search algorithm finding the nearest spatial object to a position, wherein the bounding boxes of the tree nodes below the root only cover regions where spatial objects are present and wherein the method maintains a maximum search radius value and, based on the maximum search radius, eliminates from consideration some nodes, the search radius value being decreased based on bounding box information.

25. The system of claim 19, wherein the interface obtains the position from a GPS or other navigation system.
